(19) United States
(12) Patent Application Publication
(10) Pub. No.: US 2010/0294314 A1
(43) Pub. Date: Nov. 25, 2010

(54) METHOD, APPARATUS AND FRAME STRUCTURE FOR CLEANING PIPE SURFACES, AND PIPE STRUCTURE TO DISTRIBUTE PARTICLES

(76) Inventor: Bjorn Ove Daleside, Bekkjarvik (NO)

Correspondence Address: Francis C. Hand;Carellla Byrne, 5 Becker Farm Road, Roseland, NJ, 07068-1739, US

(21) Appl. No.: 12/734,087

(22) PCT Filed: Oct. 13, 2008
(86) PCT No.: PCT/NO2008/000364

§ 371 Date: Jun. 7, 2010

(30) Foreign Application Priority Data
Oct. 12, 2007 (NO) 20075230

(51) Int. Cl. B08B 5/04; A47L 7/00

(52) U.S. Cl. 134/21; 15/320

(57) ABSTRACT

A method is described for cleaning the surface of extended bodies, such as pipelines, of contaminating materials, and it is characterised by the following features: that an apparatus (20) is arranged to surround and seal around the body (10) so that a completely closed or partially closed cleaning chamber is defined between the inside of the apparatus and the outside (12) of the body (10), that a number of spraying bodies arranged in connection with the apparatus is brought to spray the surface (12) with a pressure fluid containing an abrasive agent to loosen contaminating materials, that the mixture of contaminating materials and spent abrasive agent is led away via a suction section, in a closed way for further processing, that means are used to move the apparatus (20) along the pipe surface (12), and that the abrasive agent possibly is separated and used again. An apparatus (20), a frame construction and also a pipe construction for distribution of particles are also described.

The present invention relates to a method and an apparatus for cleaning of pipe surfaces as can be seen from the ingress of the claims 1 and 10 respectively. The invention also relates to a frame construction for manoeuvring the apparatus as described in the introduction of claim 24. The invention also relates to a pipe construction for distribution of a particle stream as described in claim 35.

With the invention one aims in particular for an apparatus where a pressure-fluid that contains an abrasive agent is used and where this is sprayed, at a high pressure, towards the surface through a number of spreading mouthpieces which are arranged around the circumference of the pipe. When the abrasive agent hits the pipe surface, rust, paint and other contaminating matter, for example, are loosened from the surface. In the following, this is described as contaminating materials. It is preferred that aluminium oxide in particle form is used as the abrasive agent, but other grainy materials, such as, for example, sand, are also well known in this area. The abrasive agent is pumped with the aid of compressed air through a mouthpiece towards the surface which is to be cleaned.

With regard to prior art, reference shall be made to the constructions that are shown in U.S. Pat. Nos. 5,191,740; 5,136,969 and 2,621,446, and also in U.S. patent application 2005/0266779. The disadvantage with these constructions is that they are heavy, have complex use function and they need lifting gear to be fitted to the pipelines that are to be cleaned. Furthermore, they are not adapted to be able to climb vertically along pipelines that lie in close bunches as is the case with the present invention.

It is one of the aims of the invention to provide a cleaning construction which is easily fitted manually.

Furthermore, one aims for the cleaning operation to take place in a closed cleaning chamber which also comprises a suction to transport away the contaminating materials that have been made loose.

It is also an aim of the invention to provide a solution where the sucked out mixture of air, abrasive agent and contaminating materials are taken out and transported to a separating unit where the contaminating materials are separated and led away to be processed in an environmentally friendly way as waste, while the abrasive agent can be recycled and used again for the cleaning of the pipe surface.

To clean the whole of the pipe circumference, the number of spray nozzles can be adjusted to any pipe dimension. Normally it is sufficient with four spray-nozzles connected to the apparatus as these are fitted to the apparatus evenly spaced apart around a corresponding pipe circumference, i.e. with a mutual spacing of 90°. With increasing pipe diameter, the apparatus can comprise several such spray-nozzles.

In this connection it is a further aim to be able to regulate the angle settings at which the spray-mouthpieces are directed at the surface to provide the most effective cleaning, i.e. that by moving the nozzles one can provide an acceptable cleaning, something which would not be sufficient if the nozzles were fixed to the apparatus. With the invention one aims in particular to provide an especially favourable and inventive movement pattern for the spray nozzles.

Furthermore, a preferred construction of the suction system of the apparatus to remove contaminating materials is provided.

Furthermore, it is an aim of the invention to provide a new solution to move the apparatus along a pipe for pipes that are set in both horizontal and vertical directions.

It is also an aim to shape the outer contours of the apparatus so that it can easily be adjusted to movement through narrow pipe passages.

The method according to the invention is characterised by the following features:

that an apparatus is set up to surround and seal around the body such that a completely closed or partially closed cleaning chamber between the inside of the apparatus and the outside of the body is defined,

that a number of spray bodies arranged in connection with the apparatus are brought to spray the surface with a pressure fluid containing an abrasive agent to loosen the contaminating materials,

that the mixture of contaminating materials and used abrasive agent is transported away via a suction section, in a closed way for further processing, and

that the abrasive agent is finally separated and is used again, and also means for bringing the apparatus alongside the body.

The preferred embodiments can be seen in the dependent claims 2-11.

The apparatus according to the invention is characterised in that it comprises a coat arranged to be set up to surround and seal around the body so that a completely closed or partially closed sealing chamber is defined between the inside of the apparatus and the outside of the body, a number of spray bodies arranged in connection with the apparatus to spray the surface with a pressure fluid containing an abrasive agent, a suction section to take away contaminating materials and spent abrasive agent, and means to bring the apparatus forward along the body. Preferred embodiments can be seen in claims 14-23.

The frame construction according to the invention is characterised in that it comprises: a holding frame for fitting of the apparatus and which surrounds an extended body (pipe), means for connection to a pipeline, and also means for axial movement in relation to the body and any means for rotating the apparatus in relation to the body. The preferred embodiments are as given in claims 25-34.

The pipe construction according to the invention is characterised in that the construction comprises the main pipe which runs into two branch pipes which form exactly equal angles α and β, respectively, with the longitudinal axis X through the main pipe, and a subsequent branched pipe for further corresponding branching of the particle stream from each of the previous pipe branches, is fitted with the branch pipe(s) turning 90° in relation to the previous pipe(s).

All aspects of the invention shall be explained in more detail with reference to the following figures, in which:

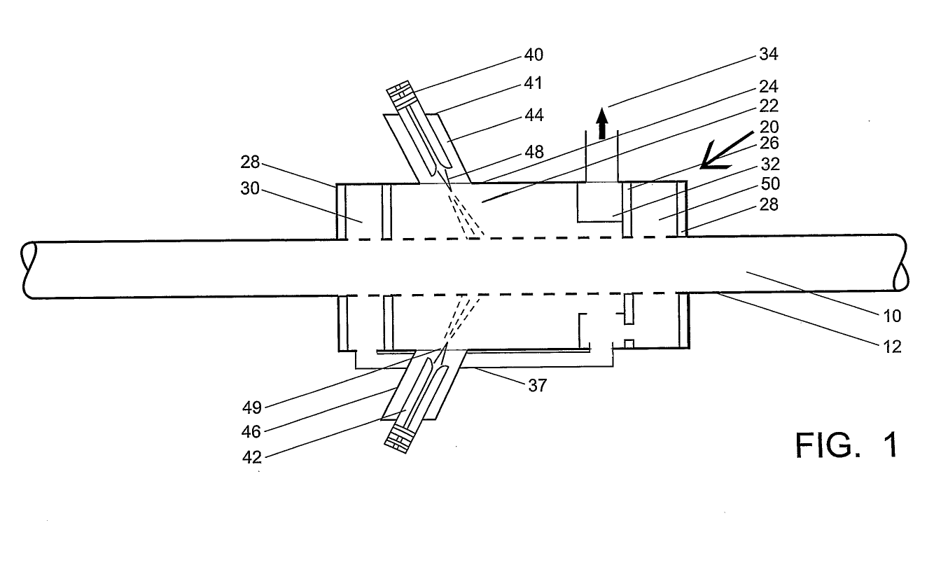

FIG. 1 shows a longitudinal side section of the cleaning apparatus according to the invention, to schematically illustrate the main elements of the apparatus.

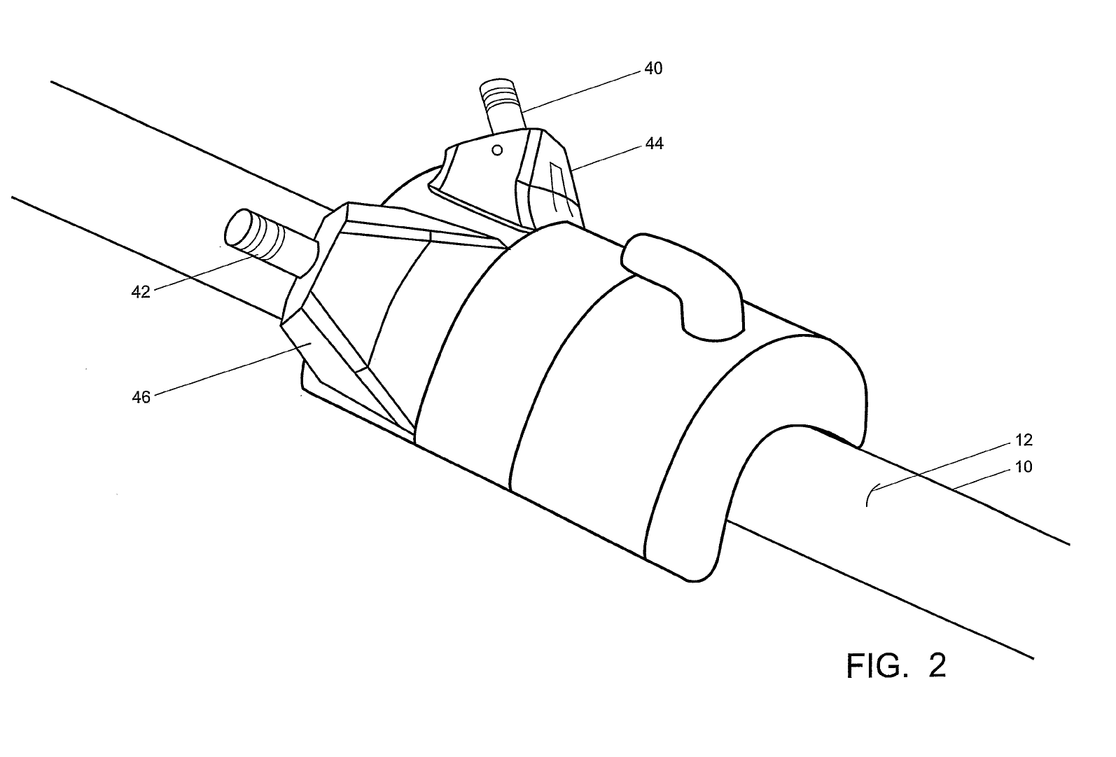

FIG. 2 shows a perspective diagram of one part of the apparatus placed in a pipe and illustrates the placing of the spreading nozzles.

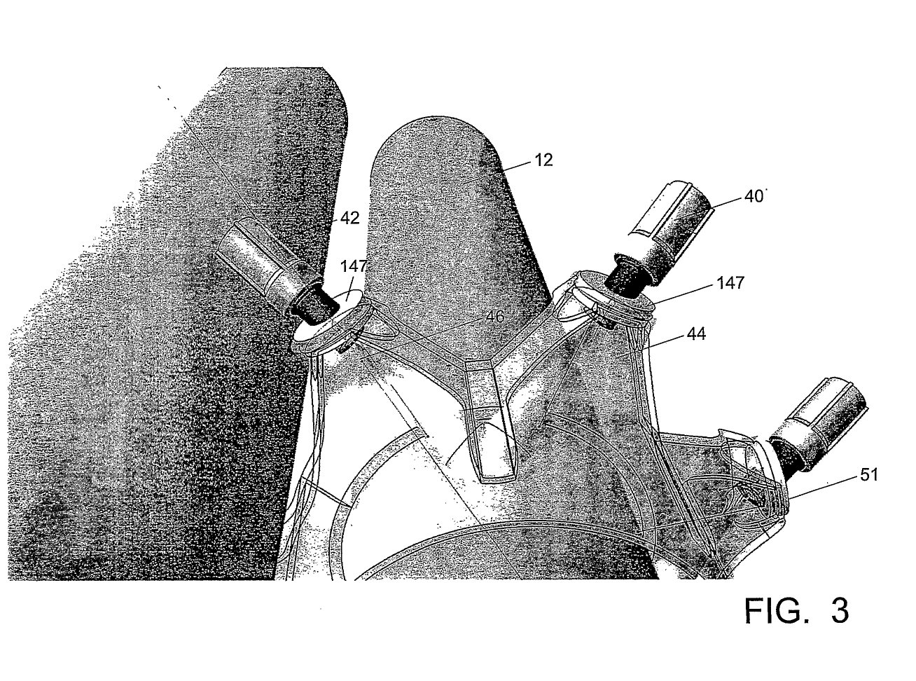

FIG. 3 shows an enlargement in perspective of parts of the nozzle section of the apparatus to show the setting of the nozzles. An adjoining pipe 10A is also indicated in the figure.

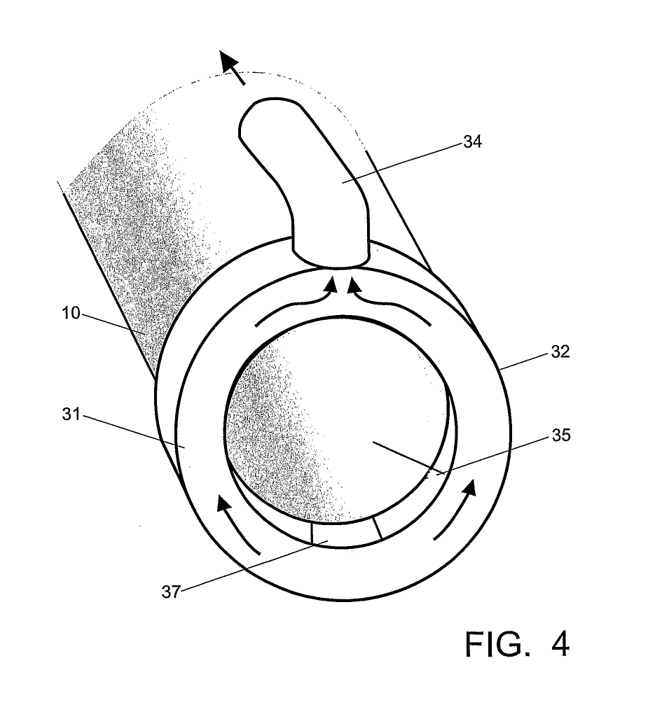

FIG. 4 shows an enlarged perspective diagram of the suction system of the apparatus.

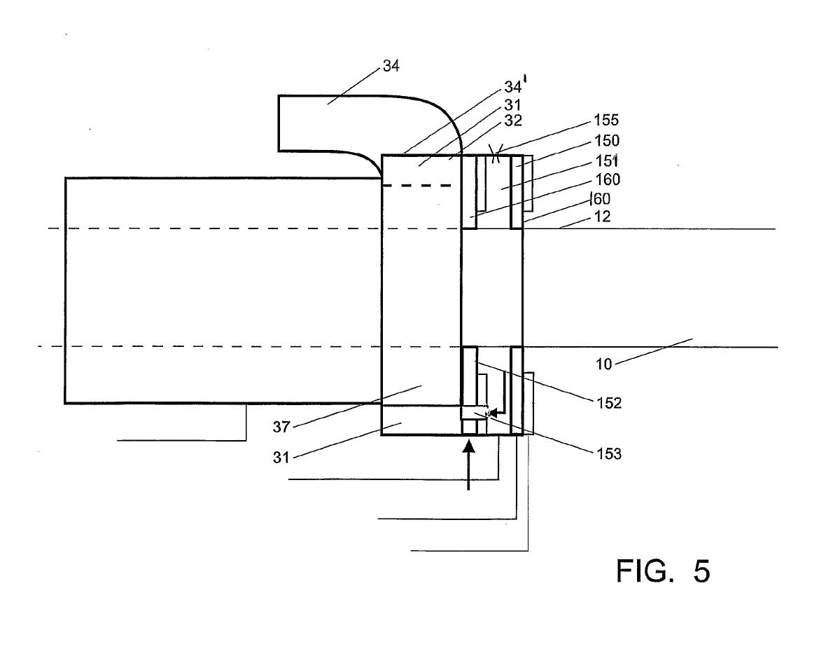

FIG. 5 shows in an enlarged section of the above how the section for the sucking out of contaminating materials is constructed and also how a sealing system against the pipe surface prevents leakage of dust-like contaminating materials to the surroundings.

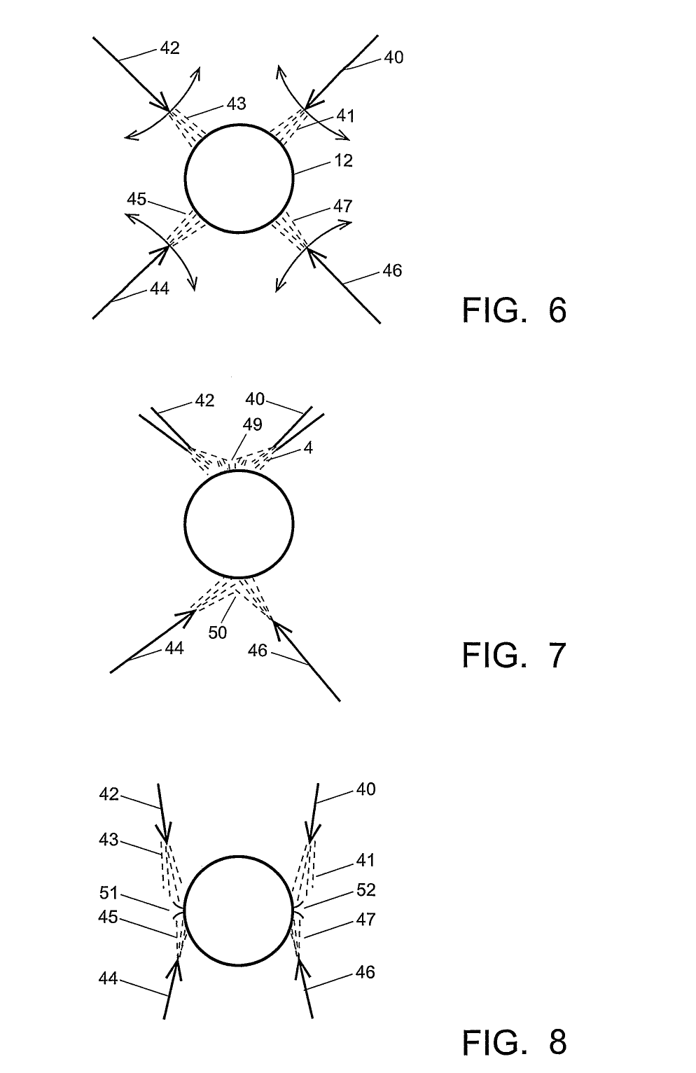

The FIGS. 6-8 show schematically how the blowing lances can be independently manoeuvred.

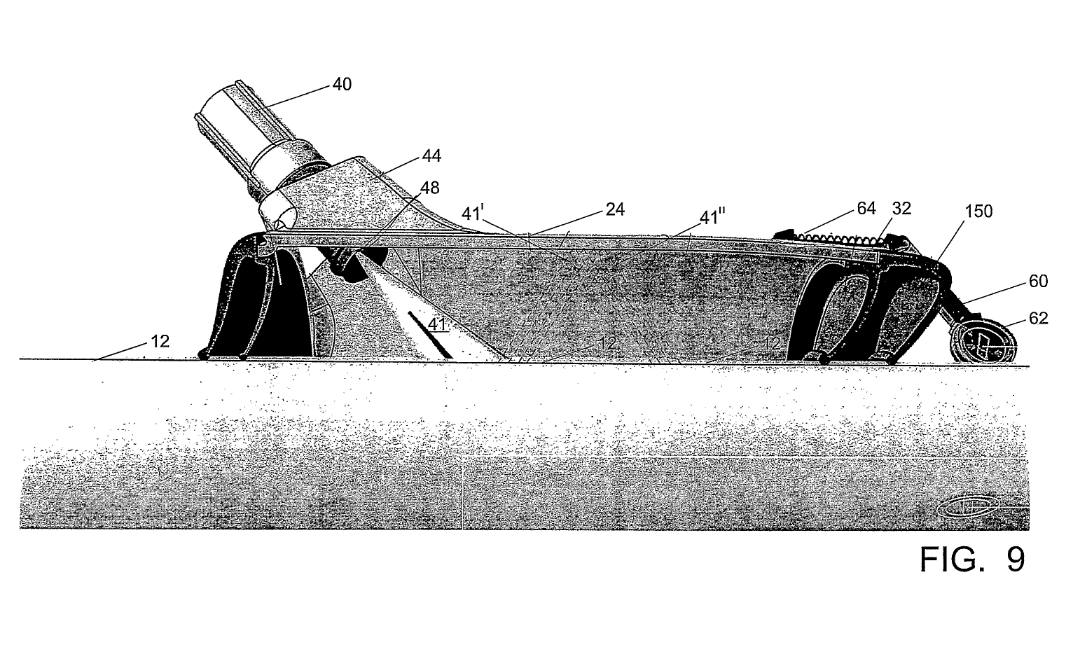

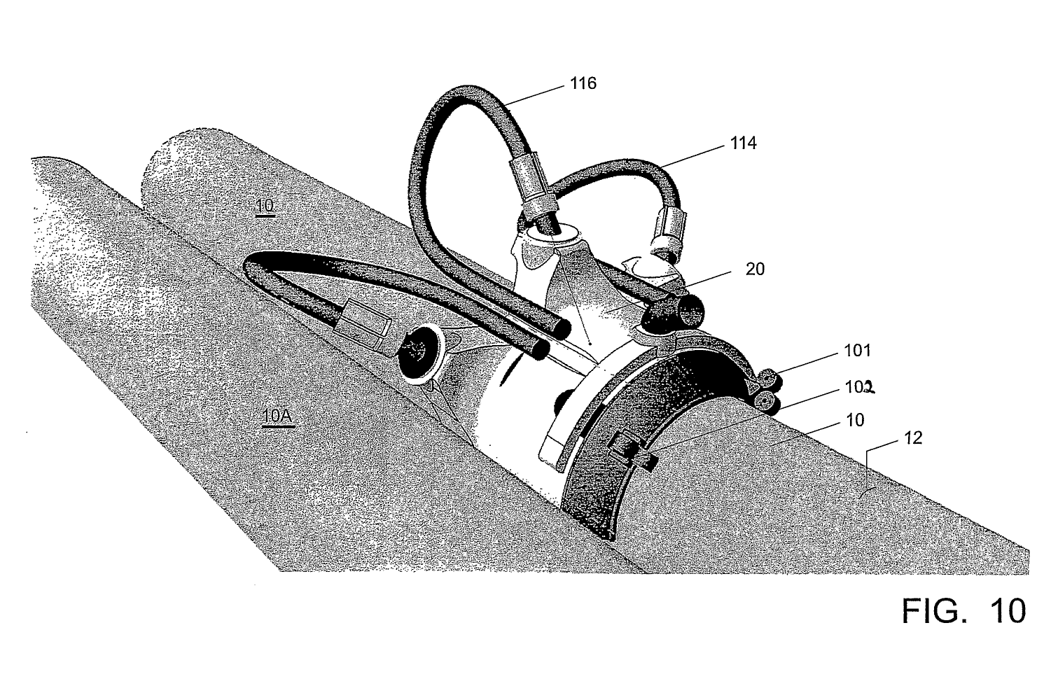

FIG. 9 shows an enlarged longitudinal section of the apparatus.

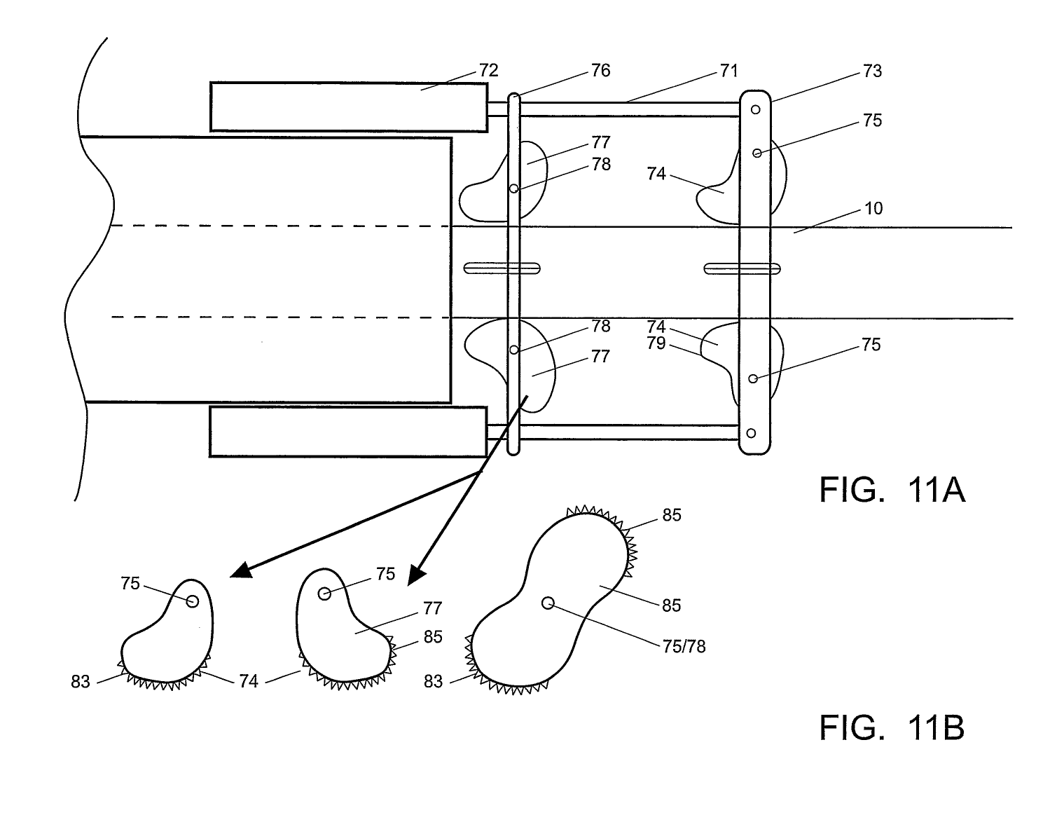

FIG. 10 shows an actual embodiment of one half part of the apparatus including a hose system for supply of pressure fluid with an abrasive agent to the nozzle.

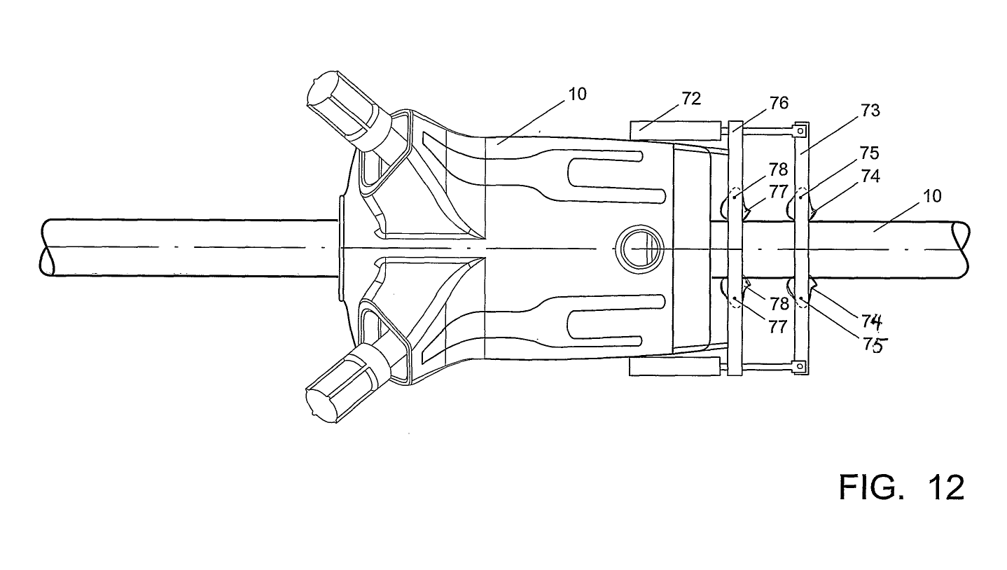

FIGS. 11 and 12 show schematically a climbing mechanism for the apparatus according to the invention.

FIG. 11B shows different embodiments of gripping tools.

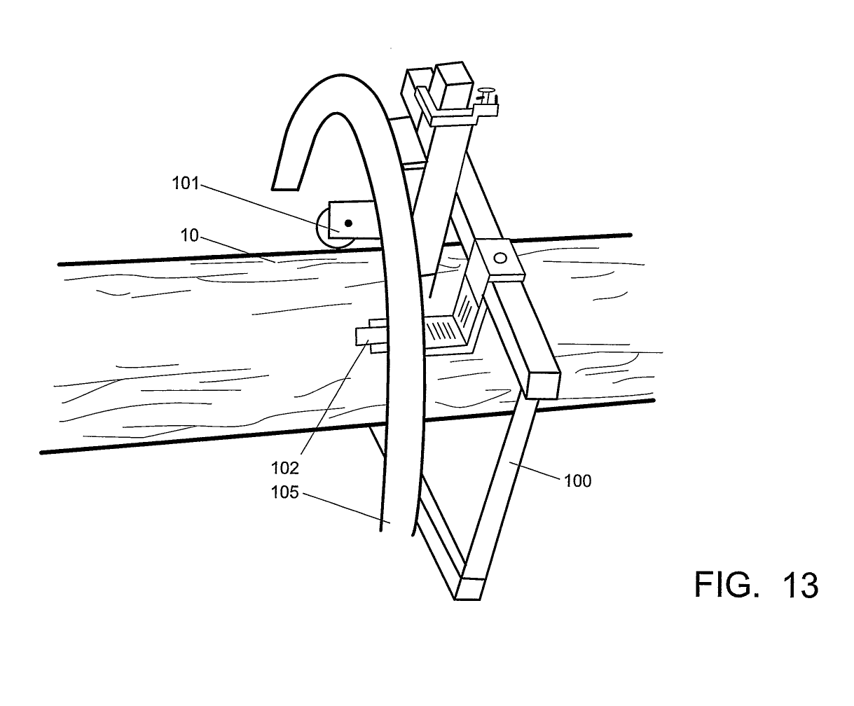

FIG. 13 shows, in perspective, the shape of a frame with wheels that can be fitted to the pipe and which comprises means to rotate the cleaning apparatus around the pipe to make the cleaning more efficient.

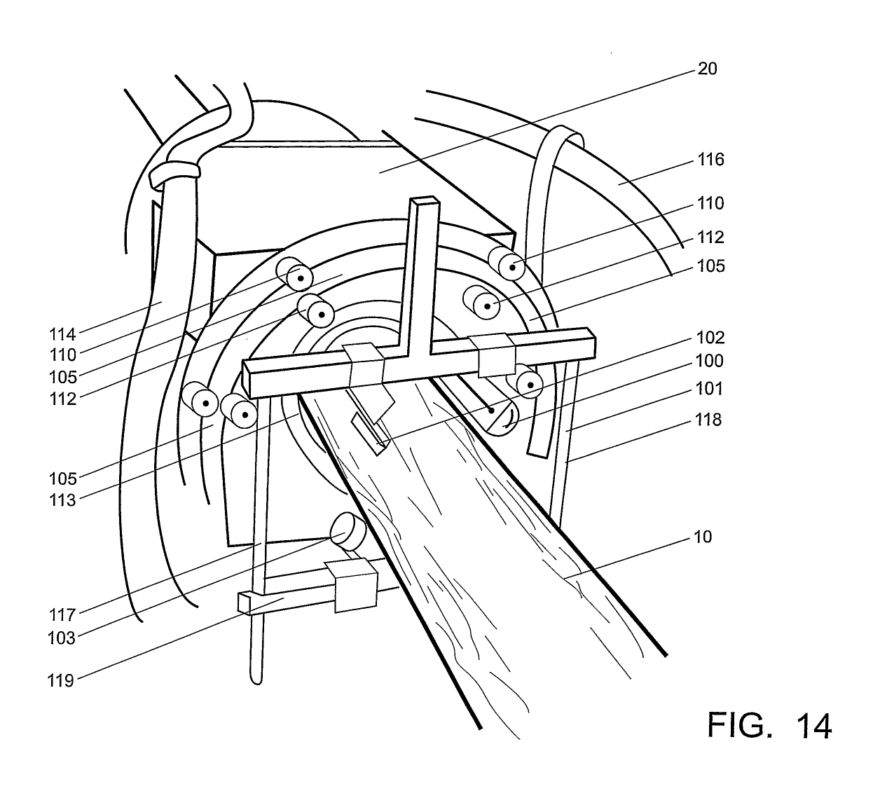

FIG. 14 shows a cleaning apparatus according to the invention inserted in the frame in FIG. 13 and illustrates how the apparatus can be rotated in the frame.

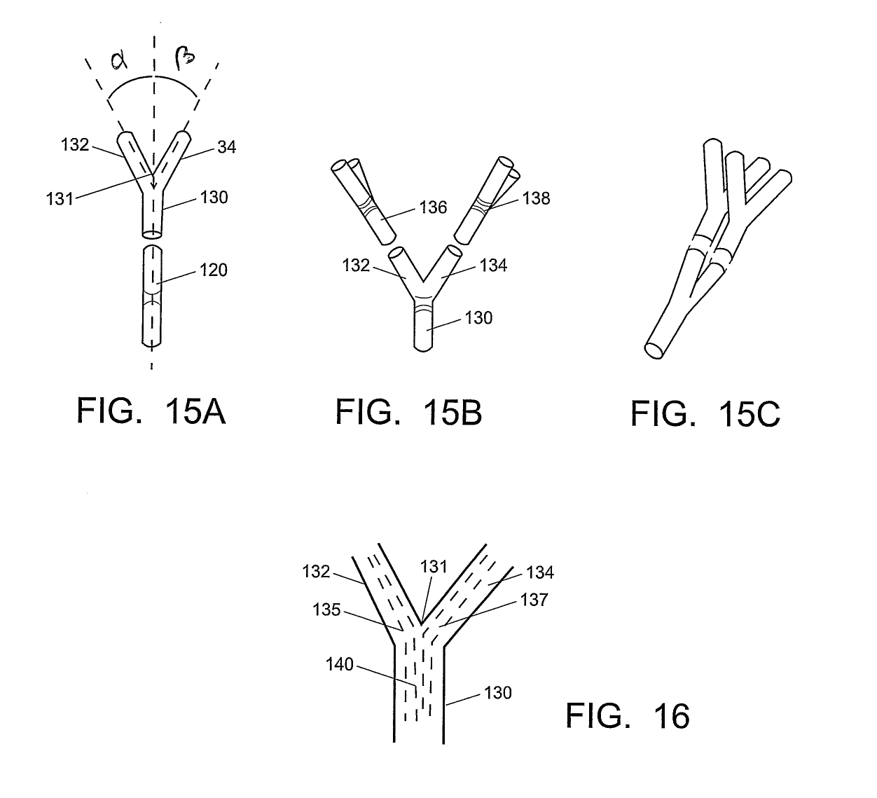

The FIGS. 15 and 16 show a construction of a pipe branch for divisions of a stream of abrasive agent in compressed air into two or more pipe branches each with an approximate equal part of abrasive agent.

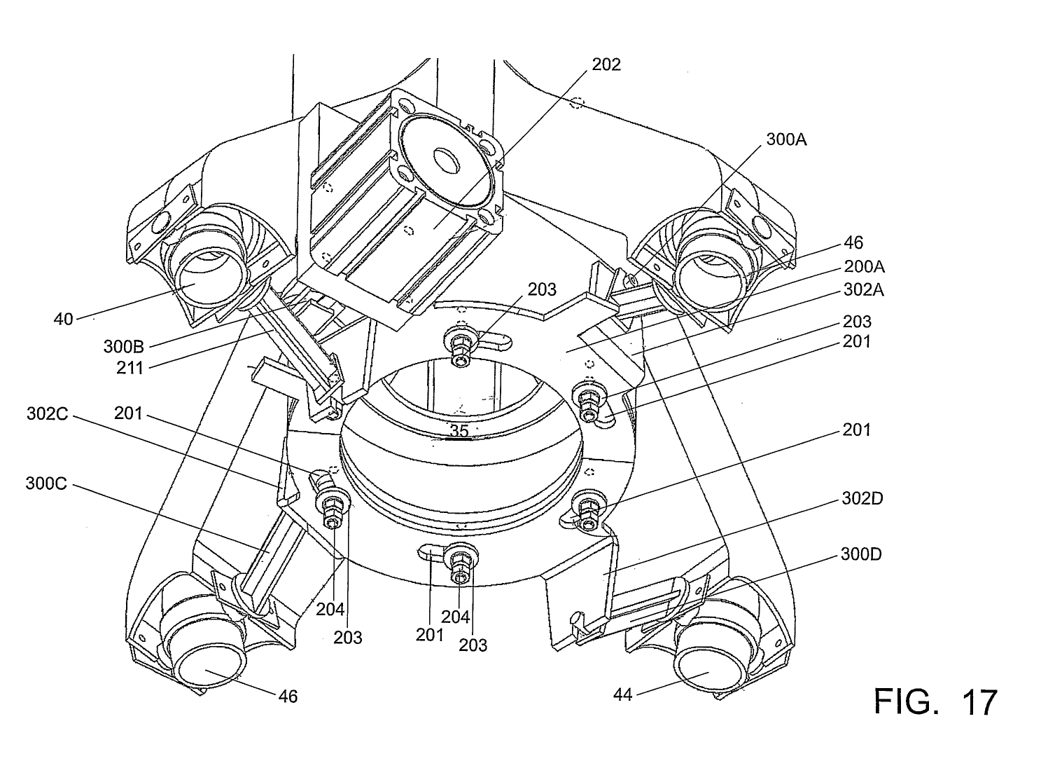

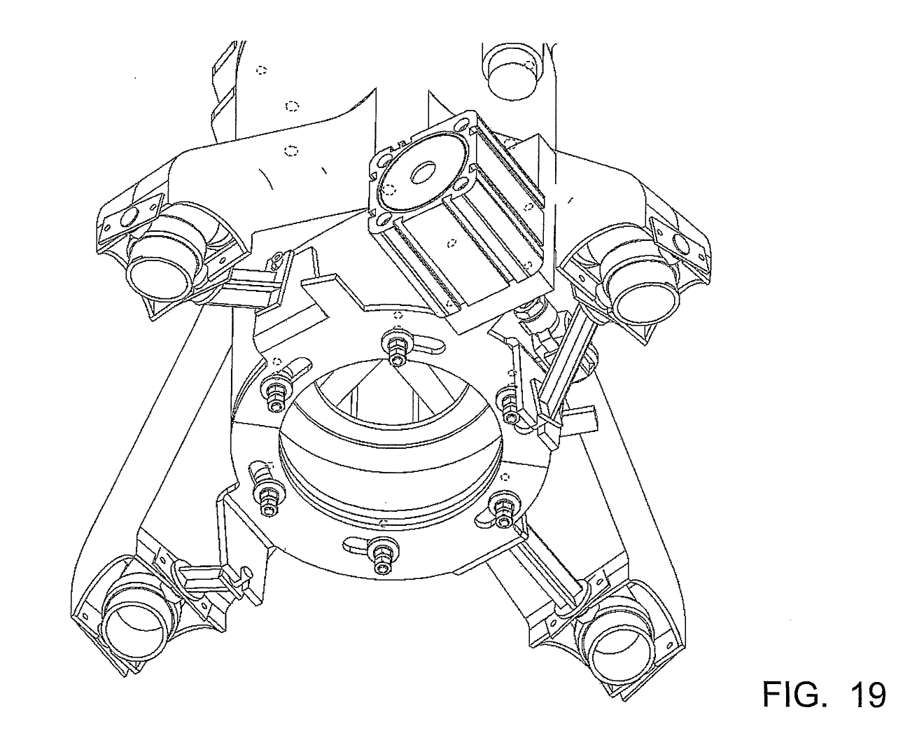

The FIGS. 17, 18 and 19 show a new construction to provide the rotation of the nozzles to and from each other as is shown in the FIGS. 6,7 and 8.

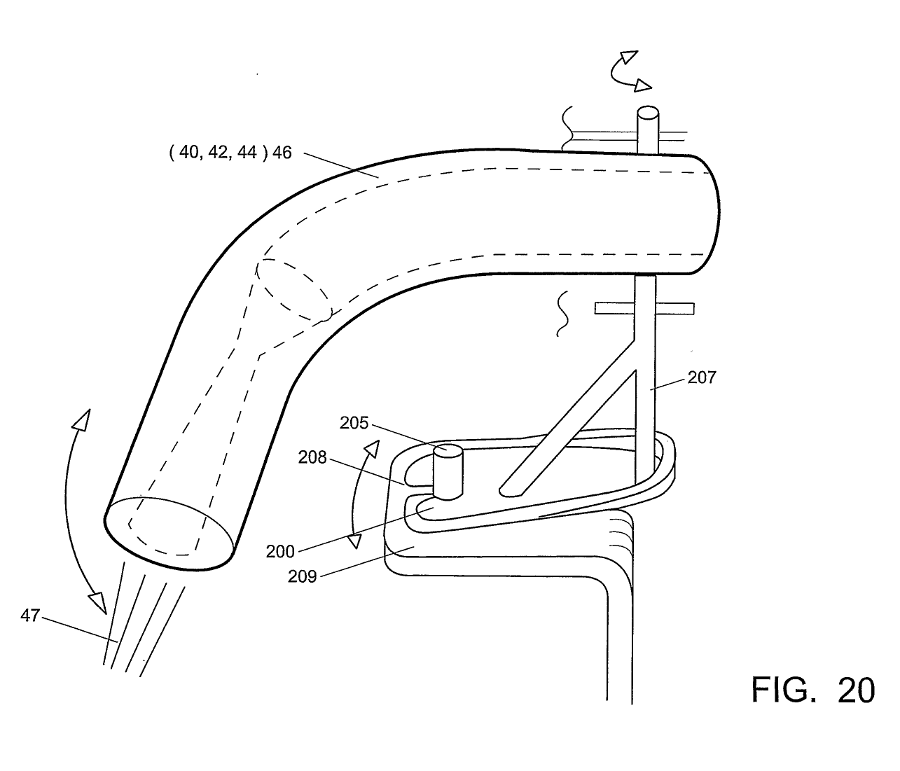

FIG. 20 shows details of the control body that performs the rotation of the nozzles.

Reference is initially made to FIG. 1 which is a longitudinal side section of a box-formed cleaning apparatus with its main elements.

An extended pipe 10 with a surface 12 that is to be cleaned is shown. The apparatus 20 according to the invention is fitted to surround the pipe and defines a closed ring-formed cleaning chamber 22 between the pipe surface 12 and the inner wall 24 of the apparatus 20.

The apparatus 20 comprises a coat-formed housing 26 with the central cleaning chamber 22 radially outside the pipe surface, and each pipe end comprises a gasket system 28 that seals sufficiently against the pipe surface 12 so that contaminating materials do not leak out into the surroundings. The gasket system 28 of the apparatus is combined with two ring-formed suction chambers 30, 32, one at each end of the apparatus, for collection of contaminating materials that flow in from the cleaning chamber 22.

The one 32 of these chambers is formed with an outlet 34 in the form of a pipe end on/through the wall of the apparatus for connection to a system that removes the contaminating materials from the apparatus.

At 40 in FIG. 1, two mutually separate spraying nozzles 40 and 42 respectively are shown, which are fitted to a holding unit 44 and 46, respectively, integrated in the outer wall of the apparatus 20. The spraying nozzles are connected via a pipe network 100 to a source of compressed air 110 and a source 120 for an abrasive agent. An important feature of the invention is shown in FIG. 9. The chamber wall 24 is arranged with a distance to the pipe surface 12 such that a recoil effect arises with the particle spray 41 (cf. FIGS. 6-8). The spray of particles is reflected back as the spray 41′ against the pipe wall 24 to be returned back to the pipe surface 12 where the particles again bring about a loosening effect on the contaminating materials, corrosion and paint further along on the pipe. This recoil effect can be achieved several times depending on the length of the apparatus/chamber 22, the spray speed and the angle of attack against the pipe surface 12.

The following describes the construction of the spraying nozzle 40 uppermost in FIG. 1 with all the nozzles being fitted around the circumference of the apparatus being formed and fitted accordingly.

An expanded house part of the wall of the apparatus is formed with said holder 42 for insertion and retention of the spraying nozzle 40 such that its mouthpiece 48, 49 is directed at the pipe surface 12. The holder 42 forms an opening 41 around the nozzle which can constitute a free connection between the surroundings and the chamber 22 to let in air, but this can also be closed with a cover 147, see FIG. 3. The number of spraying nozzles/holders arranged around the circumference will depend on the dimensions of the pipe that is to be treated with the apparatus.

As can be seen in the figures, the spraying nozzles are set at an angle in a direction toward a suction chamber at the forward end of the apparatus.

FIG. 4 shows a more detailed construction of the suction housing 32 for removal of contaminating materials from the apparatus. The housing 32 has a closed, ring-form adapted to the cross section of the apparatus, and its inner periphery is shaped with a set of gaskets to seal against the pipe surface that is led through the opening 35. Furthermore, in the inner peripheral surface, an opening 37 to an inner annular stream channel 31 is formed in the housing, for leading of contaminating materials from the chamber 22. The outer peripheral surface of the suction housing is shaped with the opening 34′ to which the pipe end 34 is connected. It can be seen that the openings 37 and 31′ are set up diametrically opposite to each other. A corresponding suction chamber 30 is formed at the “back” of the spraying nozzles. However, a corresponding outlet 31′31 is missing. Instead, a channel 37 is formed on the underside of the apparatus between the chamber 30 and the chamber 32.

Furthermore, a separate ring-formed coat 150 is formed axially on the outside of the suction housing 32 and is set up to surround the pipe 10 in the same way as the housing 32 and which is constructed close up to the suction chamber 30. The coat 150 also forms a ring-formed channel 151 that borders on to the pipe surface 12. In addition, there is a fluid connection between the channel 151 and the channel 31 in that an opening 153 is formed in the wall 152 of the apparatus between them.

To establish a natural fluid flow from the channel 151 to the suction chamber 31, the wall of the coat 150 is formed, preferably diametrically opposite to the opening 153, with a small opening 155 which lets some air into the chamber 151 all the time. It is also possible to provide a natural inlet of air via the set of gaskets, for example, when the ring gasket comprises a ring brush that brushes the pipe. Thus, as a consequence of the underpressure in the channel 31, a natural flow through the chamber 151 is set up out through the opening 153 and in to the channel 31 that removes any contaminating materials/abrasive agent that might have penetrated in, or leaked through, the seals 160.

Thereby, one obtains that at the same time as the abrasive agent/air is sprayed in against the pipe surface 12 in the chamber 22, at an overpressure, contaminating materials are led, as a consequence of the suction, together with the abrasive agent/air out through the opening 37, into the ring-channel 31 and through the opening 31′ to the pipe 31.

The constructions of the housing 30 and the coat 150 form a unit with a number of inwardly facing ring gaskets 160 that form a seal against the pipe surface 12. This unit is replaceable so that the apparatus can be adjusted to different wall thicknesses and provide sufficient sealing.

The spraying lances (the FIGS. 2-3) 40 and 42 with mouthpieces 48, 49 are fitted in the housing parts 44 and 46, respectively, such that the spraying angle in relation to the pipe surface can be varied. The lances are fitted in separate universal joints 43, set up to be rotated with the help of connected drive units (not shown in more detail).

FIG. 6 shows schematically a lance 40 with mouthpiece 48 that blows abrasive agent down onto the pipe surface 12 at an angle α to the pipe surface 12. The lance can consequently be rotated such that it is perpendicular to the pipe, or forms an angle α with the vertical. The lances are preferably set so that the pipe is sprayed in a direction forward towards the suction chamber 30, as it is depicted in all the figures.

In addition to that the angle of the lances with the longitudinal direction of the pipe can be regulated, they can also be rotated across the longitudinal direction. This is shown in the FIGS. 6, 7 and 8 which show a cross section of the pipe 10 fitted in the apparatus with the mutual position of the four spraying lances 40, 42, 44, 46 being shown. The sprays of abrasive agent are shown with the dotted lines 41, 43, 45, 47.

An Especially Preferred Regulating Pattern. FIG. 6 shows four lances 40-46 in their normal position arranged at an angle to the pipe surface 12. In this position, there is a sector of pipe surface between each pair of lances that is not cleaned as well as the pipe area that lies directly below/in front of the lance/nozzle. To overcome this advantage, the lances are manoeuvred such that two lances in a pair are made to rotate alternately towards each other and away from each other as shown in FIG. 7. When the lances are rotated in pairs towards each other, i.e. two and two sprays, 41, 43 and 45, 47, respectively, come together just at the surface and change direction downward towards the pipe surface to form common resultant sprays 49 and 50, respectively. Even if the resultant sprays do not hit the surface 12 with the same force as the individual sprays in a direction at an angle to the pipe, they lead to a very satisfactory cleaning effect.

In the first phase, the lance pairs 40, 42 and 44, 46, respectively, are slowly rotated towards each other and form said resultants 49 and 50, respectively, as shown in FIG. 7. In the next phase, as illustrated in FIG. 8, they are moved away from each other, and the lance 40 moves in towards the neighbouring lance 46 which comes towards it from the opposite side to form a new resultant spray 52 between the lances 40 and 46. Correspondingly, the lances 42 and 44 form the resultant spray 51. The arch shapes in FIG. 6 indicate the rotating pattern of the lances.

Alternatively, to achieve a satisfactory cleaning of the pipe surface, an apparatus with six, eight or more spraying lance units around the circumference can be used.

FIG. 9 shows a longitudinal section of an example of an apparatus according to the invention. The figure shows the holder unit 44 for the spraying lance 40, the spraying nozzle 48, the spray of abrasive agent and compressed air which hits the surface 12 of the pipe 10. In addition, the suction chamber 32 arranged downstream, the leakage chamber 150 and the gaskets 28 that seals against the pipe surface 12 can be seen.

The Movement of the Apparatus Along the Pipe.

The cleaning apparatus 20 can be moved along the pipe 10 with the help of a pneumatic drive system which can be driven by the same compressed air source that drives the spraying nozzles, or alternatively by the use of a hydraulic drive system.

It is preferred that the apparatus rides on the tube via a number of spring loaded support wheel units at each end of the cleaning apparatus, represented in the figure by a wheel unit 60 with wheels 62 and spring system 64. Depending on the diameter of the pipe, two, four or more such wheel units around the circumference of the pipe can be used, something which is necessary when the apparatus shall be moved along in vertically positioned pipes. Besides, the support wheels contribute to the set of gaskets adjoining the suction chambers not needing to carry the weight of the apparatus, other than to provide the necessary seal against the pipe surface.

FIGS. 11A, 11B and 12 show a principle diagram of a preferred mechanism 70 for climbing and propulsion to move the apparatus along the pipeline 10. The propulsion mechanism 70 is shown fitted directly to the cleaning apparatus 20, but can also be connected to the frame that carries the cleaning apparatus.

The propulsion mechanism is formed by a number of piston/cylinder units 71,72, where a number of pistons 71 can be pushed out or be pulled into the cylinder 72. Fitted at the end of each piston 71 is a ring 73 that can be opened and which surrounds the pipe 10 and which incorporates a number of first gripping tools 74 (locking discs) which can be regulated.

Each gripping tool 74 is formed as a disc-formed body, and is rotary secured to a shaft 75 in the ring 74 that can be opened. The axis of rotation (75) of the tool is displaced in relation to its centre. A spring, for example, a spiral spring the one end of which is fastened to the ring 73 that can be opened, while the other end is fastened to the gripping tool 74 and adjusted so that the gripping tool at all times lies spring-loaded to the pipe surface. That engagement is formed with the pipe by movement the one way and release the other way, respectively, is due to the eccentric mounting of the gripping tool in the ring that can be opened.

This relationship is used in the present invention so that the gripping tools tighten the engagement against the pipe if the apparatus is moved the one way, while the engagement is loosened when it is moved the opposite way.

Furthermore, the gripping tool surface which shall lie against the pipe is a rough or coarse surface 83 and 85, respectively, cf. FIG. 11, to avoid unintended slipping when they are in a gripping position. It can be seen in FIG. 11B that the left gripping tool 74 is the version which in this case is used in the version shown in FIG. 11A, for propulsion to the right. The middle gripping tool in FIG. 11B can be identical with the version to the left, but is rotated 180 degrees to achieve propulsion to the left. Both these types can be used.

In this way, all gripping tools around the circumference of the ring 73 are brought to work in unison either to make en engagement around the pipe 10 or to loosen its grip around the pipe 10.

A corresponding second dividable ring 76 that can be opened around the pipe 10 is rigidly connected to the climbing apparatus 70 and comprises a corresponding number of gripping tools 77 around the circumference similar to the ring 73 that can be opened and closed. These gripping tools 77, of the same type as the tools 74, have the same positioning and setting as the gripping tools 74 and set up engagement grip and loosening grip, respectively, against the pipe in the same directions in relation to the gripping tools 74 associated with the ring 73. The symmetrical setting of the pair of gripping tools 74-77 is clearly shown in FIG. 11A. This means that the cleaning apparatus according to FIG. 11A can only move towards the right. Both the sets of tools 74-77 prevent any movement to the left.

Operating Mode of the Propulsion Apparatus.

The cleaning apparatus is moved along the pipe in that the ring 73 is initially pushed out with the help of the pistons 71 at the same time as the corresponding gripping tools 74 are thereby loosened from engagement with the pipe 10, cf. FIG. 11. When the rods/ring 71/73 are fully extended, a withdrawal of the pistons 71 commences. Then the first gripping tools 74 form an engagement with the pipe 10, while the second gripping tools 77 take up a loosening position and can slide along the pipe, something which leads to the whole apparatus moving along the pipe 10. This position is shown in FIG. 12.

By alternating between pulling in and pushing out, respectively, the pistons 71, the sets of gripping tools also change their engagement with the pipe and the whole apparatus is pulled along the pipe.

When the one pair of gripping tools is in operation for movement in one direction, the other pair of gripping tools is deactivated and this change between the two pairs can be made, for example, manually or be automated, for example, pneumatically.

To the right in FIG. 11b a second preferred embodiment is shown where in one gripping tool element 81 spiked gripping surfaces 83 and 85, respectively, are integrated on the opposite sides of the element. They are set up to be fitted one set to the ring 73 that can be opened and one set to the ring 76, but with mutually opposite direction. By switching over (manually or automatically) the direction of gripping against the pipe can be changed, and thus the direction of movement can be changed.

Rotation of the Cleaning Apparatus 20.

In addition to that the cleaning lances 40-46 individually can be moved/rotated to get the best possible cleaning of the pipe surface, this can also be provided in that the whole apparatus is rotated around the longitudinal axis of the pipe 10. This can be carried out in that the apparatus is fitted in the above mentioned frame to a rotary body in the frame and when this is moved the apparatus is rotated so that the position of the spraying nozzles is changed.

Rotary Fitting of the Cleaning Apparatus 20 (FIGS. 13-14).

The cleaning apparatus is divided so that it shall be fitted to surround the pipe. This is carried out in that the one half of the apparatus is placed in position on the tube. Thereafter, the other half is led up from the underside and the two halves are fixed to each other in an in itself known way. This split into two parts is indicated in FIG. 2 which shows the upper half of the cleaning apparatus only.

FIG. 13 shows in perspective a wagon unit in the form of a square trussed frame 100 which is fitted surrounding the pipe 10 and which the one end of the cleaning apparatus 20 can be fitted to (FIG. 14). The rear part of the apparatus can be fitted in a corresponding way to a rear wagon frame. The frame comprises a set of wheels 101, 102, 103 set up to rest on and roll against the pipe 10. Furthermore, both the forward and the rear wagon frame are connected to arch-formed guiding pipes 105 with a given radius (co-axially around the pipe 10) arranged completely or partially around the pipe 10. At the end section of the cleaning apparatus, a number of pairs of runner wheels 110,112 are fitted in an arch-shape with a radius that corresponds to the radius of the guiding pipe 105. The distance between each wheel 110, 112 in a pair corresponds approximately to the thickness of the arch-shaped guiding pipe 105.

When the apparatus is fitted to the guiding pipe 105, it is set at such an angle and rotated around so that the guiding pipe(s) 105 is threaded in between the two wheels 110, 112 in a set of wheels. When the guiding pipe 105 is completely threaded onto the wheels, the cleaning apparatus can be rotated correspondingly about the wheel that is to be cleaned. This takes place with the help of drive means (not shown), such as driven by a pneumatic system.

The figure also shows schematically two of the hoses 114, 116 that bring forward the particle containing fluid to the spraying nozzles on the apparatus 20.

The truss frame 100 is formed with vertical stays 117, 118 on both sides, and the lower wheels 103 (104 which is not shown) are fitted to a horizontal stay 119 which can be moved along the vertical stays. Furthermore, the wheels 103, 104 can be moved horizontally along the horizontal stay 119. Thereby, the equipment can be adjusted to different diameter pipes. The upper set of wheels, 101,102 can be displaced correspondingly on the horizontal stay 113.

Environmentally Friendly Cleaning.

With the present invention, none of the contaminating materials which have been made loose is released into the environment as all the treatment takes place in a closed circuit. Furthermore, the mixture of contaminating materials (paint residues, corrosion dust and the like) and the particle formed abrasive agent are led, in a closed system/pipe to a processing station where a separation is carried out in that the abrasive agent is separated from the contaminating materials which can then be processed further to be sent to a proper depositing facility. The abrasive agent can be collected and is returned to the portioning unit that delivers abrasive agent into a compressed air stream which leads on to the cleaning apparatus to be sprayed out through the lances.

Distribution of Abrasive Agent in Several Pipes/Hoses.

FIGS. 15a,15b,15c show a construction of a pipe branch to be able to distribute a stream of abrasive agent in compressed air into two or more branch streams, each carrying approximately equal parts of abrasive agent.

FIG. 15A shows a section of a pipe 120 that transports compressed air containing an abrasive agent. A separate piece of a pipe branch 130 according to the invention is formed in a Y-shape where the branches 132,134 form exactly equal angles α and β, respectively, with the longitudinal axis X through the pipe end 130 before the branching. The stream of fluid through the pipe 130 consequently meets a pointed, knife-formed longitudinal gently arch-shaped edge 131 that is formed when the three pipe ends are fitted and welded together. If the particles are homogeneously distributed in the compressed air through the pipe 139, an ideal distribution of particles will take place to the two branches.

Thereby, the stream of compressed air containing the abrasive agent in the pipe 120 and the one course in 130 are distributed into two approximately identical fluid streams with approximately the same content of abrasive agent.

Each of these two streams can again be distributed corresponding to four fluid streams, each with approximately the same content of abrasive agent, as can be seen in FIG. 15B. Two mutually identical Y-shaped branch pipes 136 and 138, respectively, with a main pipe stem 120 are used for this. When these two Y-branch pipes 136 and 138, respectively, with the pipe stem 130 are fitted on separate pipe ends 132 and 134, respectively, the two pipes must be fitted such that they are set at 90° in relation to the pipe ends of the pipe 130. FIG. 15c shows pipe branches put together and rotated to a different angle. The explanation as to why this must be carried out is given in FIG. 16.

When the particle stream 140 flows through the pipe end 130 and is separated in the two branches 132 and 134, respectively, the particles in the fluid stream will be enriched along the inner wall of the pipe so that the particle density is greater close to the one half of the pipe wall 135 and 137, respectively. To obtain exactly the same separation in two particle-containing streams, the next Y-branch pipe must be set across the previous Y-branch pipe 130.

If two further corresponding Y-branch pipes are placed onto the four pipe branches, and these are turned 90°, eight branch pipes are formed and each of these eight pipes brings forward approximately the same concentration of particles (abrasive agent) with approximately the same fluid velocity. The pipes are shaped so that one pipe can, for example, be inserted manually into the other pipe.

This arrangement of branch pipes which, with their branches are set at a 90° angle in relation to the previous branching, leads to an even cleaning of the pipe surface being obtained.

An essential feature of the present invention is also illustrated in the FIGS. 3 and 10. The cleaning apparatus according to the invention is set up to operate under cramped conditions where several pipes lie closely together. In the example shown, there is an “open” space between the two adjoining spraying lances 40 and 42. The apparatus is set and brought forward so that the neighbouring pipe 10A is in position in this open space.

Consequently, with the present invention a closed and environmentally friendly pipe cleaning process is provided.

Reference is made to FIG. 17 which illustrates a new construction to provide the rotation of the nozzles towards and away from each other that is shown in the FIGS. 6, 7 and 8.

The apparatus is shown in perspective as 35 shows the hollow space in which the pipe is found when the apparatus is fitted. At the end of the apparatus a ring disc 20, composed of two ring disc halves 20A, 20B which when put together form a central opening which is exactly adapted to the opening 35, is added.

The disc is initially loose, but comprises four arch-shaped grooves 201 with mutually equal angle distance around the circumference of the ring disc. The disc is inserted at the end of the apparatus to which is fastened four axially outwardly extending bolts 203 with the same mutual angle distance around the circumference as the grooves 201. When the disc is inserted with the bolts 203 protruding, stop-discs and nuts 204 are inserted so that the disc remains in a locked position, in such a way that the disc can be rotated around the longitudinal axis of the apparatus to the extent the respective grooves permit.

The disc is mechanically connected to the movable nozzles to regulate and coordinate the movement of these. In this case, four nozzles are arranged and the disc 200 comprises four arm constructions 300 A, B, C, D which are rigidly connected to the respective nozzles. From the peripheral part of the disc 200, four ears 302 A, B, C, D together extend in the axial direction. These ears 302 extend alternately axially backward and axially forward, respectively from the disc periphery. The figure shows that the ears 302A and 302C extend backward and 302B and 302D forward. That the ears extend alternating forward and backward contribute to the control of the nozzles that can be seen in the figure.

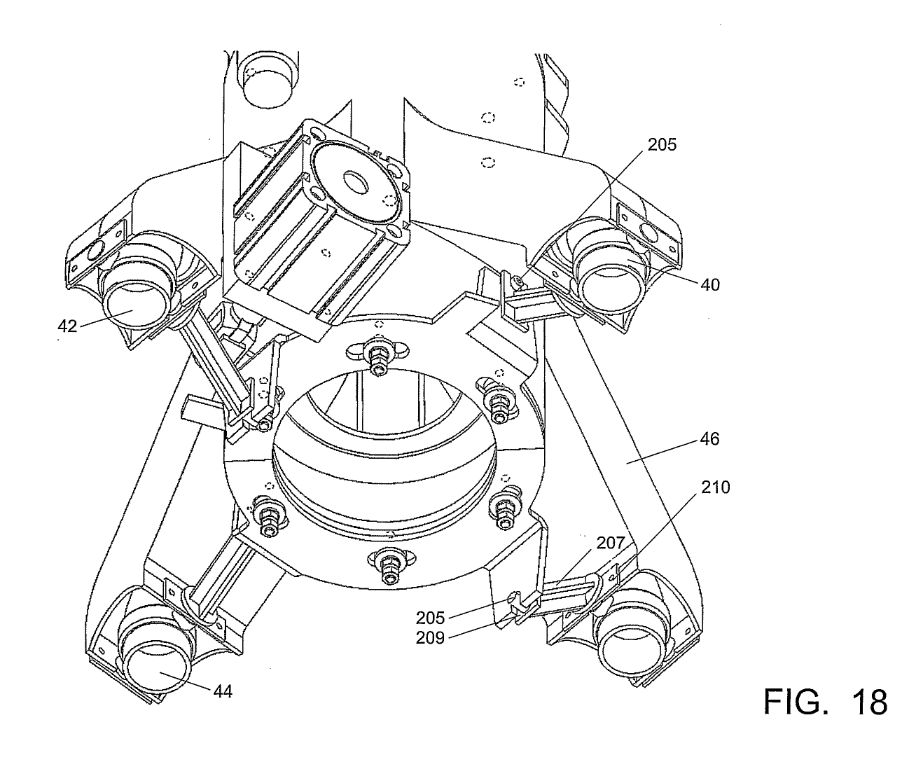

FIG. 17 shows the disc 200 placed in its position furthest to the left (indicated with the position of the bolts 203), FIG. 18 shows the disc rotated to the right in its central position and FIG. 18 shows the disc rotated to the extreme position to the right.

The Connection of the Disc to the Nozzle Lances.

To explain this coupling, reference is made to the FIGS. 17 and 20. A peg 205 extends up from the ear 205. An arm 207 forms an L-shape with an arm plate 205 lying onto the surface of the ear 200. A slit 208 in which the peg 205 lies is formed in the arm plate 209. Thus, the plate 205 is movable on the ear surface 200. The arm 207 extends upwards to a securing point 210 in the nozzle lance 46. This securing point 210 is a rigid connection between arm and lance. The direction of spraying from the lance in toward the pipe surface for the cleaning agent is shown by 47.

The ring disc is set up to rotate in the track in the circular direction of the apparatus with the help of a compressed air driven cylinder 202 that rotates the disc 200 forward and backward. Each nozzle 40, 42 and 44, 46 is tied together with the circular plate in the respective ears that face forward in the direction of the pipe for the nozzles 42 and 46 and backward for the direction of the pipe for the nozzles 42,46. This will lead to the nozzles moving in their respective holders (see above) in a desired pattern as shown in FIGS. 6, 7 and 8, when the disc rotates. This means that, from a starting point of FIGS. 6 and 7, the lances 40 and 42 will move towards each other each time the disc 200 is rotated clockwise to the right and they move away from each other when it is rotated anti-clockwise to the left.

1. Method for cleaning of the surface of extended bodies, such as pipelines, for contaminating materials, characterised by the following features:
that an apparatus (20) is arranged to surround and seal around the body (10) such that a completely or partially closed cleaning chamber is defined between the inside of the apparatus and the outside (12) of the body (10),
that a number of the spraying bodies connected to the apparatus are made to spray the surface (12) with a pressure fluid containing an abrasive agent to loosen the contaminating materials,
that the mixture of contaminating materials and spent abrasive agent is led away via a suction section in a closed way for further treatment,
that means are applied to move the apparatus (20) along the pipe surface (12), and
that the abrasive agent can possibly be removed and reused.

2. Method according to claim 1, characterised in that a number of spraying nozzles are used each formed as a lance with a spreading mouthpiece and the angle of spraying can be regulated by rotating the lance in a holder in the apparatus.

3. Method according to claims 1-2, characterised in that each holder/lance is set up to be adjusted between an angle perpendicular to the pipe surface and a position inclined towards the pipe surface in a direction towards the suction section.

4. Method according to claims 1-2, characterised in that two lances in a pair around the circumference of the pipe are brought to rotate alternately towards each other and away from each other, when they rotate towards each other, two and two sprays 41, 43 and 45, 47, respectively, come together just above the surface and change direction down towards the pipe surface to form common resultant sprays 49 and 50, respectively.

5. Method according to claim 4, characterised in that the rotating movements of the lances are synchronised so that two adjoining lances are alternately rotated towards each other and away from each other, and that each individual lance in its two extreme positions alternately forms a resultant spray with its two most adjacent (on either side) lances.

6. Method according to any of the preceding claims, characterised in that the lances (40, 42, 44, 46) are connected to a rotary ring disc (20) fitted to the apparatus, whereby when the ring disc is rotated, the lances rotate in their holders as described above.

7. Method according to any of the preceding claims, characterised in that the four lances are fitted to the ring disc via respective L-shaped arm parts 207, 209 fastened to axially directed ears 200 on the ring disc, said ears alternately turn axially forwards and axially backwards.

8. Method according to any of the preceding claims, characterised in that a ring disc 200 is applied which can be removed in that it is divided into two halves 220A and 220B, respectively.

9. Method according to claim 1, characterised in that the suction section comprises an outlet which is subjected to an underpressure for suction of contaminating materials/abrasive agent through a ring-formed closed section with an inlet from the chamber (24) and an outlet to the suction section.

10. Method according to claims 1 and 9, characterised in that any possible leakage of contaminating materials from the suction section, for example, through the sealing system, is collected in a leakage section which is fluid-connected with the suction section.

11. Method according to claims 9-10, characterised in that a leakage section is used both upstream and downstream of the blowing chamber and any contaminating materials present in the leakage section is made to flow into the suction section for further removal and processing.

12. Method according to any of the preceding claims, characterised in that the apparatus is rotated about the longitudinal axis of the body to improve the cleaning effect of the abrasive agent against the pipe surface.

13. Apparatus for cleaning the surface of an extended body, such as pipelines, for contaminating materials, characterised in that it comprises
a coat arranged to be set up (20) to surround and seal around the body (10), so that a completely closed, or partially closed, cleaning chamber is defined between the inside of the apparatus and the outside (12) of the body (10),
a number of spraying bodies arranged in connection to the apparatus to spray the surface (12) with a pressure fluid containing an abrasive agent,
a suction section for removal of contaminating materials and spent abrasive agent, and
means to move the apparatus (20) along the pipe surface (12).

14. Apparatus according to claim 13, characterised in that each spraying body comprises a lance with a spreading mouthpiece, said lance is set up to change the angle of spray against the surface in that a holder for the lance can be rotationally regulated.

15. Apparatus according to claims 13-14, characterised in that the holder comprises a universal joint for the lance, such that the lance can alter the angle setting between an angle perpendicular to the pipe surface and a position inclined to the pipe surface.

16. Apparatus according to claims 13-15, characterised in that two lances in a pair around the circumference can be rotated alternately towards each other and away from each other, when they rotate towards each other, two and two sprays 41, 43 and 45, 47, respectively, come together just above the surface and change direction downwards towards the pipe surface to form common resultant sprays 49 and 50, respectively.

17. Apparatus according to claims 13-16, characterised in that the rotary movements of the lances are synchronised so that two adjacent lances can rotate alternately towards each other and away from each other, and that each individual lance in its two extreme positions alternately forms a resultant spray with its two closest adjacent (on either side) lances.

18. Apparatus according to claims 13-17, characterised in that the suction section forms a ring-formed section with an inlet from the chamber (24) and an outlet to the suction section, with the inlet and outlet preferably arranged to run diametrically opposite to each other.

19. Apparatus according to claims 13-18, characterised in that it comprises a leakage section which is fluid-connected to the suction section, with the suction section being set up between the blowing chamber and the leakage section.

20. Apparatus according to claims 13-19, characterised in that it comprises two leakage sections, one upstream of and one downstream of the blowing chamber, with both leakage sections fluid-connected to the blowing chamber.

21. Apparatus according to claims 13-20, characterised in that the suction sections of the apparatus comprising of ring-formed seals, can be replaced to be adapted to different pipe diameters.

22. Apparatus according to any of claims 13-21, characterised in that it lies against the surface (12) of the body (10) via a number of support wheels (60, 62) to ease the movement along the body.

23. Apparatus according to any of the claims 13-22, characterised in that it is divided into two parts so that it can be fitted to surround a pipe, where the halves are arranged onto the pipe and fixed to seal against each other with tightening loops, or the like.

24. Frame construction for manoeuvring of the apparatus according to the preceding claims, characterised in that it comprises:
a holder frame for fitting of the apparatus, and which surrounds an extended body (pipe),
means for connection to a pipeline, and also
means for axial movement in relation to the body, and
possible means for rotating the apparatus in relation to the body.

25. Frame construction according to claim 24, characterised in that the means for axial movement comprises:
a number of pressure cylinder units 71,72 with respective pistons that can be pushed out and pulled in arranged around the circumference and comprise a number of first gripping tools 74 which can grip around and fix the construction to the pipe (10) in a detachable way,
a number of other gripping tools fastened to the frame, and which can grip around the pipe in a detachable way,
with alternating pushing out and pulling in of the pistons in the cylinders, and corresponding gripping activity by the tools, the frame can be moved along the pipe.

26. Frame construction according to claims 24-25, characterised in that the apparatus is moved along the pipe in that a number of other gripping tools 77 are brought to make an engagement with the pipe 10, whereupon the pistons 71 are pushed out at the same time as a number of first gripping tools 74 loosen their engagement with the pipe (FIG. 11), and when the pistons are fully pushed out and a withdrawal of the piston commences, the first gripping tools 74 form an engagement with the pipe, while the second gripping tools 77 loosen their engagement and can slide along the pipe, something that leads to the whole apparatus moving along the pipe 10 (FIG. 12).

27. Frame construction according to claims 24-26, characterised in that the gripping tools are rotary fitted about an axis 75, 78, said axis is eccentrically placed and is spring-loaded against the pipe.

28. Frame construction according to claims 24-27, characterised in that the construction comprises means to rotate the cleaning apparatus in the holding frame.

29. Frame construction according to any of the claims 24-28, characterised in that the means for rotating in relation to the body comprises a frame 100 arranged to surround the pipe 10 to which the cleaning apparatus can be fitted, and the frame corporate means (101, 102, 103, 104) to rest on and roll on relative to the pipe 10, and also to rotate the apparatus.

30. Frame construction according to claims 24-29, characterised in that the frame comprises arch-formed guiding pipes 105 with a given radius (coaxially around the pipe 10) which guiding bodies (110, 112) connected to the apparatus can be moved in relation to so that the apparatus can be rotated.

31. Frame construction according to claims 24-30, characterised in that the construction comprises forward and rear frames 100 in between which the apparatus is fitted.

32. Frame construction according to claims 24-31, characterised in that the guiding bodies are a number of pairs of runner wheels 110,112, in an arch-shape with a radius which corresponds to the radius of the guiding pipe.

33. Frame construction according to claims 24-32, characterised in that the distance between each wheel 110, 112 in a pair corresponds approximately to the thickness of the arch-shaped guiding wheel 105.

34. Frame construction according to claim 33, characterised in that the apparatus is fitted in that two wheels in a set of wheels are threaded in to the guiding pipe(s) 105, whereby the cleaning apparatus can roll on the guiding pipe and thus be rotated about the pipe (10), which can be provided with the help of a compressed air system (not shown).

35. Frame construction for distribution of a particle stream from a main pipe into several branch streams, characterised in that the construction comprises the main pipe (130) which is split into two branch pipes (132, 134) that form exactly equal angles α and β, respectively, with the longitudinal axis X through the main pipe (130), and that a second branched pipe (136, 138) for further corresponding branching of the flow of particles from each of the preceding branch pipes (132, 134), are fitted with the branch pipes (136, 138) turning 90° in relation to the previous branch pipe(s) (132,134).
